(19) United States
(12) Patent Application Publication
(10) Pub. No.: US 2022/0316169 A1
(43) Pub. Date: Oct. 6, 2022

(54) Pile Head Girdling Device

(71) Applicant: CHINA MCC5 GROUP CORP. LTD, Chengdu, Sichuan (CN)

(72) Inventor: Li LUO, Chengdu, Sichuan (CN)

(21) Appl. No.: 17/594,802

(22) PCT Filed: Mar. 18, 2021
(86) PCT No.: PCT/CN2021/081547

§ 371 Date: Oct. 29, 2021

(30) Foreign Application Priority Data
Mar. 23, 2020 (CN) 202020373607.5

(51) Int. Cl. E02D 9/00; B26D 1/14

(52) U.S. Cl. CPC E02D 9/00; B26D 1/14

(57) ABSTRACT

The present invention discloses a pile head girdling device comprising a track arranged on a pile head and coaxial with the pile head, an electric saw installation base arranged on the track in a sliding mode, an electric saw support rotationally arranged on the electric saw installation base and an electric saw arranged on the electric saw support. The beneficial effects of the present invention are as follows: according to the solution, the electric saw cutting position on the pile head is effectively controlled on the same plane, thereby improving the quality of cutting the pile head; and the electric saw cutting position is guided and limited by means of the track, thereby improving the cutting efficiency and precision.

### TECHNICAL FIELD

The present invention relates to the technical field of building construction, in particular to a pile head girdling device.

### BACKGROUND

In the pile head breaking construction process of prior art, the reinforcement cover of pile head is stripped by means of a pneumatic pick, and then the pile head is broken by annularly drilling holes on it. However, the construction is labor-intensive and low-efficiency with poor effect of pile head breaking.

Alternatively, the pile head breaking may be accomplished by means of a manual-type electric saw. The method is: after excavation of a pile cap, a main reinforcement of a steel reinforcement cage and an acoustic pipe are manually chiseled out by means of a pneumatic pick to separate the pile head, and then the pile head is hoisted by means of a large machine. The deficiencies of the method are as follows: (1) difficult and quite time-consuming detection of the acoustic pipe; (2) relatively slow progress and low efficiency in chiseling out the main reinforcement of the steel reinforcement cage and the acoustic pipe; (3) relatively severe damage to the main reinforcement; and (4) uneven pile head after breaking and damage to pile foundation to some extent.

### SUMMARY

To overcome the deficiencies of the prior art, an object of the present invention is to provide a pile head girdling device, which is used for improving the efficiency and precision of cutting a pile head and reducing the damage to the pile head.

The present invention is carried out by the following technical solution: a pile head girdling device comprising a track arranged on a pile head and coaxial with the pile head, an electric saw installation base arranged on the track in a sliding mode, an electric saw support rotationally arranged on the electric saw installation base and an electric saw arranged on the electric saw support.

Further, in order to better realize the object of the present invention, the electric saw is articulated with a guide rod, the track is provided with a regulating wheel articulated with the guide rod, and the regulating wheel is connected with the pile head in a rolling mode.

Further, in order to better realize the object of the present invention, two guide rods are arranged.

Further, in order to better realize the object of the present invention, a regulating rod is arranged between the guide rods, one end of the regulating rod is articulated with one of the guide rods, and the other end of the regulating rod is connected with the other guide rod in a sliding mode.

Further, in order to better realize the object of the present invention, the electric saw installation base is provided with a circular-arc guide support, and the guide support is provided with a guide roller connected with the track in a rolling mode.

Further, in order to better realize the object of the present invention, two layers of tracks are arranged, the electric saw installation base is arranged between the two layers of tracks, and two guide supports are provided and arranged in one-to-one correspondence with the tracks.

Further, in order to better realize the object of the present invention, the electric saw support is provided with a motor, and the motor is connected with the electric saw in a transmission mode by means of a driving chain.

The beneficial effects of the present solution are as follows:

According to the solution, the electric saw cutting position on the pile head is effectively controlled on the same plane, thereby improving the quality of cutting the pile head; and the electric saw cutting position is guided and limited by means of the track, thereby improving the cutting efficiency and precision.

### BRIEF DESCRIPTION OF THE DRAWINGS

FIG. 1 is a structural diagram of a pile head girdling device;

FIG. 2 is a top view of the pile head girdling device;

FIG. 3 is a structural diagram of a guide support; and

FIG. 4 is an installation diagram of the pile head girdling device.

Symbols in the Figures: 1—track, 2—electric saw installation base, 21—guide support, 22—guide roller, 3—electric saw support, 4—electric saw, 5—guide rod, 6—regulating wheel, 7—regulating rod and 8—handle.

### DESCRIPTION OF THE PREFERRED EMBODIMENTS

The present invention will be further described in detail in combination with examples, but the present invention is not limited to the following embodiments.

### Embodiment 1

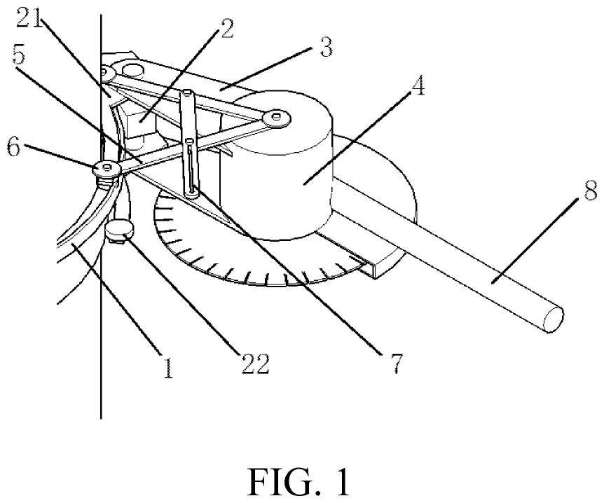

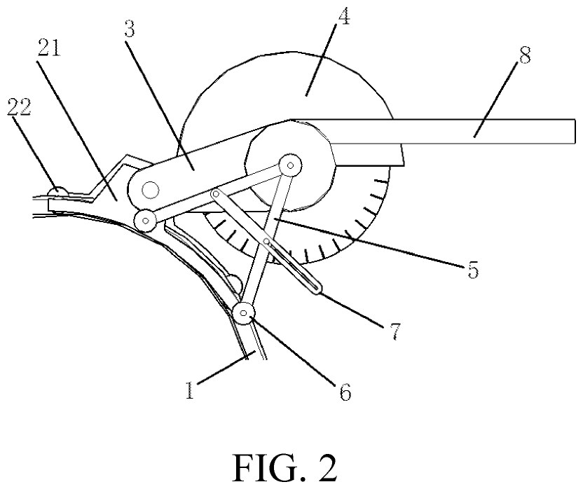

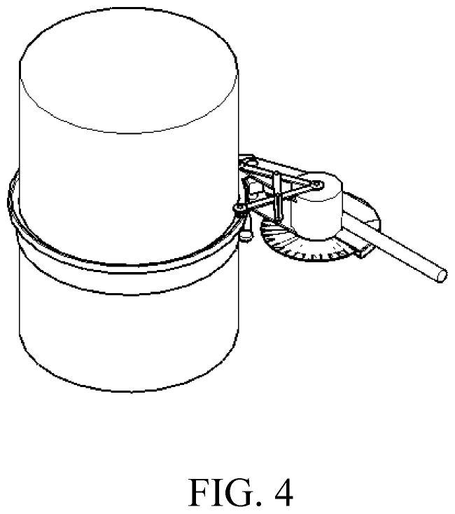

As shown in FIG. 1, FIG. 2 and FIG. 4, the present embodiment discloses a pile head girdling device, which comprises a track 1 arranged on a pile head and coaxial with the pile head, an electric saw installation base 2 arranged on the track 1 in a sliding mode, an electric saw support 3 rotationally arranged on the electric saw installation base 2 and an electric saw 4 arranged on the electric saw support 3.

The diameter of the track 1 is designed according to the diameter of the pile head, a control line is marked on the pile head, and the track 1 is arranged with reference to the control line to keep the track 1 coaxial with the pile head. The cutting with the electric saw 4 is properly controlled to meet the design requirements according to the relative position between the electric saw 4 and the track 1. When the pile head needs to be cut, supported by the electric saw installation base 2, the electric saw 4 is controlled to rotate relative to the articulated joint on the electric saw installation base 2, thereby the electric saw 4 is capable of being pushed to cut into the pile head to a certain depth after starting. Then the electric saw installation base 2 is pushed to drive the electric saw 4 to move along the track 1 as a whole, so as to continuously cut the pile head. After the pile head cutting, a pneumatic pick is used to chisel out a V-shaped groove from top to bottom and from outside to inside to strip the concrete and expose the reinforcement at the top of the pile, thus completely separating the reinforcement from the concrete.

As the track 1 is kept in a fixed position, the electric saw 4 cutting position on the pile head is controlled on the same plane, thereby improving the cutting precision, reducing the damage to the pile head during the cutting process, and ensuring the construction quality. The construction precision and construction efficiency are improved by positioning and guidance through the track 1.

The electric saw 4 is provided with a handle 8, which is convenient for pushing the electric saw 4 to move back and forth for construction and operation.

### Embodiment 2

On the basis of the above-mentioned embodiments, in the present embodiment, the electric saw 4 is articulated with a guide rod 5, the track 1 is provided with a regulating wheel 6 articulated with the guide rod 5, and the regulating wheel 6 is connected with the pile head in a rolling mode.

The supporting function of the guide rod 5 for the electric saw 4 is conducive to improving the stability of the electric saw 4 and make work easier for the worker. The relative rolling motion between the regulating wheel 6 and the pile head guides the electric saw 4, thereby controlling the cutting precision of the electric saw 4 on the pile head.

In the present embodiment, two guide rods 5 may be arranged, thereby enhancing the function of guiding and supporting the electric saw 4 and ensuring the construction quality and construction precision.

In the present embodiment, a regulating rod 7 is arranged between the guide rods 5, one end of the regulating rod 7 is articulated with one of the guide rods 5, and the other end of the regulating rod 7 is connected with the other guide rod 5 in a sliding mode. When the electric saw 4 is controlled to move towards the pile head, the included angle between the guide rod 5 and the other guide rod 5 will gradually increase, leading to decreased rigidity of the guide rods 5. The regulating rod 7 always connecting the guide rod 5 and the other guide rod 5 ensure the rigidity, stability and position precision of the guide rods 5, thus ensuring the guide precision of the regulating wheel 6.

The guide rod 5 connected with the regulating rod 7 in a sliding mode is further provided with a locking device for locking the regulating rod 7. When the electric saw 4 moves in position, the regulating rod 7 is locked by means of the locking device, thus the included angle between the two guide rods 5 is fixed. When a force is applied to the electric saw 4 to make it move to the pile head, the electric saw 4 fails to continue cutting into the pile head to a deeper position, thereby maintaining the relative position between the electric saw 4 and the pile head and improving the cutting quality.

### Embodiment 3

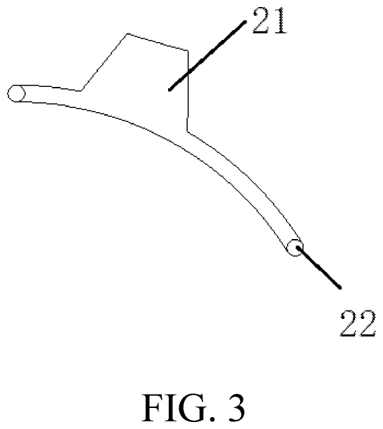

As shown in FIG. 3, on the basis of the above-mentioned embodiments, in the present embodiment, the electric saw installation base 2 is provided with a circular-arc guide support 21, and the guide support 21 is provided with a guide roller 22 connected with the track 1 in a rolling mode, thereby improving the stability of the electric saw installation base 2, enhancing the bearing capacity of the electric saw installation base 2, and preventing the electric saw installation base 2 from falling off the track 1.

In the present embodiment, two layers of the tracks 1 are arranged, the electric saw installation base 2 is arranged between the two layers of tracks 1, and two guide supports 21 are provided and arranged in one-to-one correspondence with the tracks 1, thereby further improving the stability and bearing capacity of the electric saw installation base 2, and effectively preventing the electric saw installation base 2 from falling off.

In the present embodiment, the electric saw support 3 is provided with a motor, and the motor is connected with the electric saw 4 in a transmission mode by means of a driving chain, thereby facilitating driving the electric saw 4 to rotate.

The other steps in the present embodiment are identical to those in the above-mentioned embodiments and will not be repeated herein.

The above-mentioned embodiments are only preferred embodiments of the present invention and are not restricted thereto in any way. Any simple modification and equivalent alterations made to these embodiments based on the technical essence of the present invention fall within the protection scope of the present disclosure.

1. A pile head girdling device, characterized by comprising a track (1) arranged on a pile head and coaxial with the pile head, an electric saw installation base (2) arranged on the track in a sliding mode (1), an electric saw support (3) rotationally arranged on the electric saw installation base (2) and an electric saw (4) arranged on the electric saw support (3).

2. The pile head girdling device according to claim 1, characterized in that the electric saw (4) is articulated with a guide rod (5), the track (1) is provided with a regulating wheel (6) articulated with the guide rod (5), and the regulating wheel (6) is connected with the pile head in a rolling mode.

3. The pile head girdling device according to claim 2, characterized in that two guide rods (5) are arranged.

4. The pile head girdling device according to claim 3, characterized in that a regulating rod (7) is arranged between the guide rods (5), one end of the regulating rod (7) is articulated with one of the guide rods (5), and the other end of the regulating rod (7) is connected with the other guide rod (5) in a sliding mode.

5. The pile head girdling device according to claim 1, characterized in that the electric saw installation base (2) is provided with a circular-arc guide support (21), and the guide support (21) is provided with a guide roller (22) connected with the track (1) in a rolling mode.

6. The pile head girdling device according to claim 5, characterized in that two layers of tracks (1) are arranged, the electric saw installation base (2) is arranged between the two layers of tracks (1), and two guide supports (21) are provided and arranged in one-to-one correspondence with the tracks (1).

7. The pile head girdling device according to claim 1, characterized in that the electric saw support (3) is provided with a motor, and the motor is connected with the electric saw (4) in a transmission mode by means of a driving chain.
